(19) United States
(12) Patent Application Publication
(10) Pub. No.: US 2011/0072025 A1
(43) Pub. Date: Mar. 24, 2011

(54) RANKING ENTITY RELATIONS USING EXTERNAL CORPUS

(75) Inventors: Roelof van Zwol, Badalona (ES); Vanessa Murdock, Barcelona (ES); Borkur Sigurbjornsson, Barcelona (ES)

(73) Assignee: Yahoo!, Inc., a Delaware corporation, Sunnyvale, CA (US)

(21) Appl. No.: 12/562,794

(22) Filed: Sep. 18, 2009

(51) Int. Cl. G06F 17/30

(52) U.S. Cl. 707/750; 707/E17.071

(57) ABSTRACT

Exemplary methods and apparatuses are disclosed that may be used to provide or otherwise support ranking entity relations utilizing the vocabulary of at least one external corpus for use in search engine information management systems.

### BACKGROUND

1. Field

The present disclosure relates to search engine information management systems and, more particularly, to search engine information management systems that rank entity relations for a given query.

2. Information

With an enormous amount of information and documents being available and accessible over the Internet, search engine information management systems and information retrieval techniques continue to evolve and improve. A wide variety of data, such as, for example, text documents, image files, audio files, video files, or the like, is continuously being managed or otherwise located, retrieved, accumulated, stored, communicated, and analyzed. Various information databases with web as well as non-web content have become commonplace, as did related communication networks and computing resources that help users to access relevant information.

The Internet is widespread and omnipresent. The World Wide Web or simply the Web, provided by the Internet, is growing rapidly because of the large volume of information being added daily, if not hourly. In many instances, tools and services may be utilized to quickly identify and provide access to such information. For example, service providers may employ search engines to enable a user to search the Web using one or more search terms (e.g., a query), and to efficiently locate documents and/or files that may be of particular interest to that user. In addition to efficiently retrieving information, search engines may employ one or more functions or processes to rank retrieved documents or files, and to display such documents or files in an order that may be based on their relevance, usefulness, popularity, web traffic, recency, and/or some other measure.

Search engines may further arrange and present retrieved documents or files in a variety of different formats. Because of the very large amount and distributed nature of information on the Web, locating and presenting a desired portion of the information in an efficient manner is valuable for both users inexperienced at web searching and for advanced “web surfers.” Accordingly, it may be desirable to develop one or more methods, systems, and/or apparatuses that implement efficient information retrieval and presentation techniques for large networks, such as, for example, the Web, as well as for smaller networks or data repositories and personal computing devices.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is a schematic diagram illustrating certain features and/or processes associated with an exemplary computing environment according to one implementation.

FIG. 2 is a flow diagram illustrating an exemplary process for ranking entity relations according to one implementation.

FIG. 3 is a flow diagram illustrating the process of FIG. 2 where a query is representative of a particular geographic location.

FIG. 4 is a flow diagram illustrating certain features of the process of FIG. 3.

FIGS. 5 and 6 are illustrative representations of screenshot views of a user display representative of search results according to one implementation.

FIG. 7 is a schematic diagram illustrating an exemplary computing environment associated with one or more special purpose computing apparatuses supportive of the process of FIG. 2.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

Some exemplary methods and apparatuses are disclosed herein that may be used to rank entities associated with the vocabulary of at least one external corpus by utilizing entity relations. Generally, entity relations may describe recognized associational attributes between and/or among the entities or may refer to some characteristic of mutual dependency among the entities. As used herein, “external corpus” may refer to an organized collection of any type of data accessible over the Internet and/or associated with an intranet, such as, for example, one or more web documents, web sites, databases, discussion forums or blogs, query logs, audio, video, image, or text files, and/or the like. In addition, an external corpus may comprise an open or fluid vocabulary, e.g., the content of an external corpus may change over time. Optionally or alternatively, the vocabulary of an external corpus may be static, e.g., may remain unchanged over time. Some exemplary implementations of methods and apparatuses disclosed herein may utilize more than one external corpus, and such corpora may be separate or overlapping, and/or one corpus may be a subset of another. Finally, as will be seen, external corpora may be subdivided into one or more extraction corpora and one or more ranking corpora. For example, in some implementations, one or more external corpora may be used to extract relations of interest between the entities (e.g., extraction corpora), and one or more external corpora may be used to rank such relations (e.g., ranking corpora) utilizing one or more entity association-based measures, statistical or otherwise, derived from such ranking corpora. It should be appreciated that extraction and/or ranking corpora may or may not be separate or overlapping.

The vocabularies of external corpora may, although not necessarily, be organized around domain-specific topics and may include many entity classes or types (e.g., cities, people, landmarks, locations, animals, jobs, holidays, etc.). In turn, an entity type may have a very large number of subordinate or subsumed relations with other entities within the corpus. For example, in a large database (e.g., GeoPlanet™, Yahoo! Travel, etc.), a city (i.e., entity type), such as London, may be related to a large number of other entities (e.g., Big Ben, London Eye, Tower Bridge, British Museum, Trafalgar Square, etc.) through a subsumed “city—landmarks” relation. In some implementations, such databases may be used as extraction corpora that may be separate from ranking corpora, and may be utilized to extract some or all relations of interest, as mentioned above. In addition to subsumed relations, a particular entity type may also have a very large number of suggestive associations and/or relations with other entities. As a way of illustration, Venice (i.e., entity type “city”) may be associated with or related to a very large number of entities (e.g., museums, hotels, wine tasting, carnival, sightseeing, gondolas, graffiti, film festival, etc.) via a “location—event/activity” relation. As such, it may be advantageous to rank such entities to retrieve the most relevant relations in response to a query. It should be appreciated that these are merely examples of various entities within one or more external corpora and that claimed subject matter is not limited to these examples.

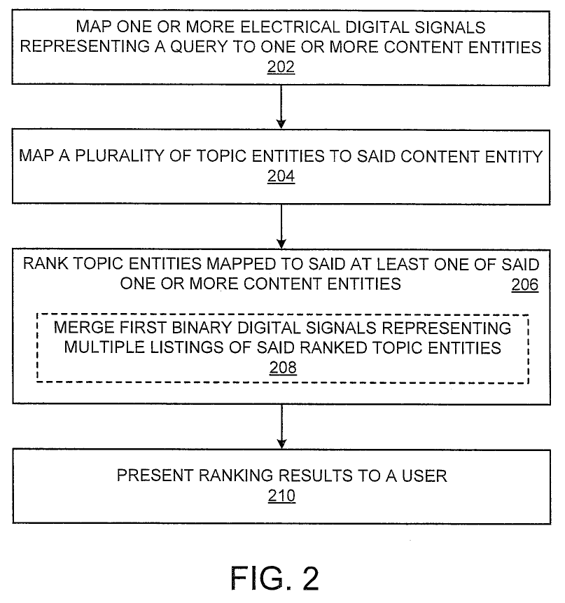

Following the above examples and taking into account, but not necessarily limiting to, such hierarchical nature of at least some associations between and/or among the entities, entity type “London” may be classified as a “content entity,” and one or more of the entities related to such an entity type through a subsumed relation (e.g., Big Ben, London Eye, Tower Bridge, British Museum, Trafalgar Square, etc.) may be classified as a “topic entity.” In a similar fashion, “Venice” may be classified as a “content entity” suggestively associated with and/or related to multiple topic entities (e.g., “museums,” “hotels,” “wine tasting,” “carnival,” “sightseeing,” “gondolas,” “graffiti,” “film festival,” etc.) within the vocabulary of one or more external corpora. Features of content entity-topic entity relations will be described in greater detail below with reference to FIGS. 2-4.

Alternatively, although not necessarily, a query may comprise a search request including one or more key terms submitted to a search engine by a user to obtain desired information. As will be described in greater detail below, conceptually, a query may also be represented, for example, as an entity class or type having subsumed and/or associational relations with a large number of entities in the vocabulary of at least one external corpus. As such, a query, thus, may have multiple aspects and/or concepts that may be advantageously utilized by a ranking function, as will be seen.

More specifically, as illustrated in the example implementations of the present disclosure, a query may be mapped to one or more content entities associated with the vocabulary of at least one external corpus. In an implementation, such external corpora may represent ranking corpora, for example, and may be used to rank entity relations, as previously mentioned and as described below. For a particular content entity, some or all relations with a sufficient degree of relevance (i.e., topic entities) may be collected using the vocabulary so as to create a plurality of content entity-topic entity pairs. Co-occurrence statistics of content entity-topic entity pairs may be analyzed, and a probability of a particular topic entity co-occurring together with a particular content entity in the corpus may be calculated. For a particular content entity, then, topic entities may be ranked using such probability of co-occurrence. The results of such ranking may be implemented for use with a search engine or other similar tools responsive to search queries.

Before describing some example methods, apparatuses, and articles of manufacture in greater detail, the sections below will first introduce certain aspects of an exemplary computing environment in which information searches may be performed. It should be appreciated, however, that techniques provided herein and claimed subject matter is not limited to these example implementations. For example, techniques provided herein may be adapted for use in a variety of information processing environments, such as, e.g., database applications, etc. In addition, any implementations or configurations described herein as “exemplary” are described herein for purposes of illustrations and are not to be construed as preferred or desired over other implementations or configurations.

The World Wide Web, or simply the Web, may provide a vast array of information and may utilize hypermedia, such as HyperText Markup Language (HTML), to enable the formatting and proper displaying of contents of a web document. A “web document,” as the term used herein, is to be interpreted broadly and may include one or more signals representing any source code, search result, file, and/or data that may be read by a special purpose computing apparatus during a search and that may be played and/or displayed to a user. As a way of illustration, web documents may include a web page, an e-mail, an Extensible Markup Language (XML) document, a media file, and the like, or any combinations thereof.

Considering the enormous amount of information available on the Web, it may be desirable to employ one or more search engines to help a user to locate and efficiently retrieve web documents of a particular interest. A search engine may determine relevance of a web document to a query based, for example, on an analysis of keywords, tags, text within such web document, and so forth. As used herein, “keywords” may refer to one or more words used in a title and/or a phrase within such document that may designate or otherwise suggest a content of such web document. “Tags” may refer to one or more identifying terms assigned to a web document and descriptive of such web document in a way that enables a user to locate the document again by filtering a collection of web documents associated with such one or more identifying terms.

Under some circumstances, it may also be desirable for a search engine to utilize one or more processes to rank web documents and to assist in presenting relevant and useful search results to a user. As will be seen, a search engine may employ one or more ranking functions, such as, for example, a ranking function based on a probability of co-occurrence derived from co-occurrence statistics of related entities in the vocabulary of at least one external corpus. A user, thus, may receive and view a web page that may include a set of search results listed in a particular order.

In some implementations, a displayed web page may include one or more segmented portions incorporating search results, and may provide an ergonomic and efficient interactive user environment. For example, one or more navigation tools or other interactive content associated with web documents, such as, for example, selectable tabs, hyperlinks, images, icons, etc., may be included in one or more segmented portions of a displayed web page in a manner that may allow for selective interaction by a user. As a way of illustration, one segmented portion of a displayed web page may display a listing of ranked topic entities, and another segmented portion of a web page may display one or more web documents electronically associated with or otherwise grouped together with respect to a particular topic entity. A user, thus, may select a particular topic entity (e.g., Big Ben) from the ranked list within one portion of the page, and may browse through a number of web documents associated with Big Ben within another portion of the page without leaving the original search results. This may save the user time and make navigating among web documents much easier. Of course, this is merely one possible example. Many forms of web page navigation may be employed.

A user, via a user interface, may access a particular web document by clicking on a hyperlink or other like tool associated with such document. As used herein, “click” or “clicking” may refer to a selection process made by any pointing device, such as, for example, a mouse, track ball, touch screen, keyboard, or any other type of device operatively enabled to select search results via a direct or indirect input from a user.

In some implementations, one or more dynamic searching techniques may be utilized to return the most current or “fresh” information in response to a query. Because of the enormous amount of data being added to the Web every day, maintaining an up-to-date index may be a challenging and expensive task. In some embodiments, a crawler may perform a new search and/or re-visit old content updating their index of web documents about once a month. Constraints, such as, for example, the size of the Web, the cost and finite nature of the bandwidth for conducting crawls, especially of deep Web resources, may contribute to slow network scan rates. As a result, query returns may be time-restrictive and may produce the results that have been moved or deleted. As a way of illustration, the use of a scalable search engine integration via a direct feed from one or more external corpora may help to return timely or “live” search results to a user's query including content deletions, additions, and/or modifications made in such corpora. Thus, unlike searching in which search results are obtained, indexed, and, therefore, ranked via a crawl, such dynamic searching and, therefore, ranking, may be performed at the time of a query. As such, the ranking of the search results may change in response to a submission of a query by a user.

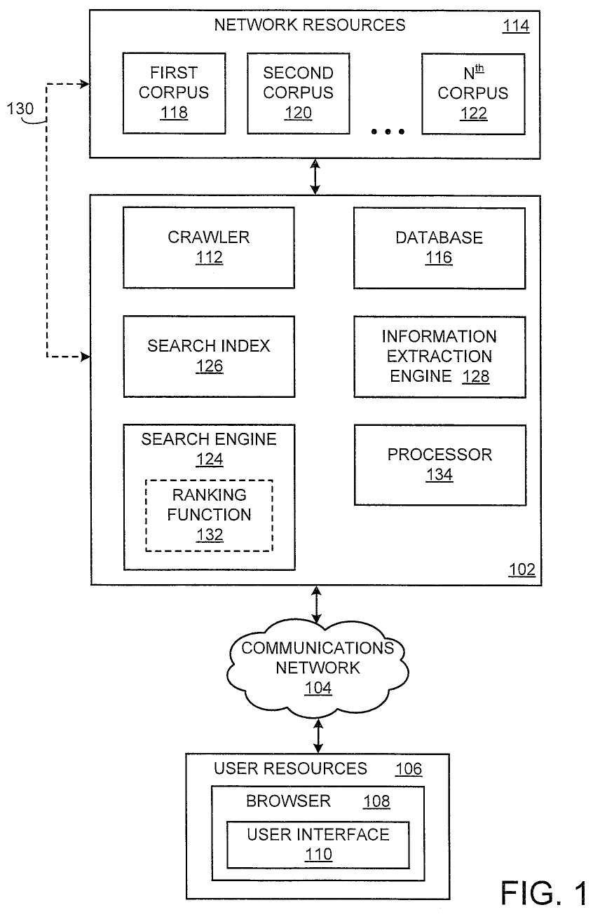

With this in mind, attention is now drawn to FIG. 1, which is a schematic diagram illustrating certain functional features and/or processes associated with an exemplary computing environment 100 that may be operatively enabled to perform ranking of entities associated with the vocabulary of at least one external corpus by utilizing entity relations. Exemplary computing environment 100 may be operatively enabled using one or more special purpose computing apparatuses, data communication devices, data storage devices, computer-readable media, applications, and/or instructions, various electrical and/or electronic circuitry and components, input data, etc., as described herein with reference to particular exemplary implementations.

As illustrated in the present example, computing environment 100 may include an Information Integration System (IIS) 102 that may be operatively coupled to a communications network 104 that a user may employ in order to communicate with IIS 102 by utilizing user resources 106. It should be appreciated that IIS 102 may be implemented in the context of one or more search systems associated with the public networks (e.g., the Internet, the WWW) private networks (e.g., intranets), for public and/or private search engines and websites, Real Simple Syndication (RSS) and/or Atom Syndication (Atom)-based applications and websites, and the like.

User resources 106 may comprise, for example, any kind of computing device, mobile device communicating or otherwise having access to the Internet over a wireless network (e.g., notepads, personal digital assistants, cellular phones, etc.), and the like. User resources 106 may include a browser 108 and a user interface 110 that may initiate the transmission of one or more electrical digital signals representing a query. Browser 108 may facilitate an access to and viewing of web pages over the Internet and may HTML web pages as well as pages specifically formatted for mobile devices (e.g., WML, XHTML Mobile Profile, WAP 2.0, C-HTML, etc.). User interface 110 may comprise any appropriate input means (e.g., keyboard, mouse, touch screen, digitizing tablet, etc.) and output means (e.g., display, speakers, etc.) suitable for a user interaction with user resources 106.

In the configuration shown, IIS may employ a crawler 112 to access network resources 114 and locate web documents associated with web sites, web pages, and the like. Crawler 112 may also follow one or more hyperlinks associated with such web documents and may store all or part of a web document (e.g., XTML, XML, URL, FTP, or other pointers of information) in a database 116. Web crawlers are well known and need not be described here in greater detail.

As previously mentioned, network resources 114 may include various corpora of information, such as, for example, a first corpus 118, a second corpus 120, and so forth up through a Nth corpus 122, any of which may include any organized collection of any type of data accessible over the Internet and/or associated with an intranet (e.g., web documents, web sites, databases, discussion forums or blogs, query logs, audio, video, image, or text files, and the like). In addition, one or more external corpora may comprise an open or fluid vocabulary, e.g., the content of the corpus may change over time. Optionally or alternatively, the vocabulary of one or more external corpora may be static, e.g., may remain unchanged over time. Such corpora may be separate or overlapping, and/or one corpus may be a subset of another. Also, external corpora may be subdivided into one or more extraction corpora and one or more ranking corpora. For example, in some implementations, one or more external corpora may be used to extract relations of interest between the entities (e.g., extraction corpora), and one or more external corpora may be used to rank such relations (e.g., ranking corpora) utilizing one or more entity association-based measures, statistical or otherwise, derived from such ranking corpora. It should be appreciated that extraction and/or ranking corpora may or may not be separate or overlapping.

IIS 102 may further include a search engine 124 supported by a search index 126 and operatively enabled to search for and/or help index data associated with web documents. For example, search engine 124 may communicate with user interface 110 and may retrieve and display search results associated with a search index 126 in response to one or more digital signals representing a query.

The data associated with search index 126 may be generated by an information extraction engine 128 based on extracted content of an XTML file associated with a particular web document during a crawl. In some implementations, it may be advantageous to utilize techniques to keep search index 126 sufficiently up-to-date. As such, IIS 102 may be operatively enabled to subscribe to or otherwise be integrated with one or more external corpora via a “live” or direct feed, indicated generally in dashed line at 130, versus an application programming interface (API), for example. As a way of illustration, IIS 102 may be integrated via a direct photostream feed, for example, from Flickr® photo sharing application, thus, providing to a user the most current search results associated with Flickr® database. Of course, this is merely one possible example, and claimed subject matter is not so limited.

As previously mentioned, it may be desirable for search engine systems to employ one or more processes to rank web documents, files, or search results to assist a user in presenting relevant and useful information in response to a query. Accordingly, IIS 102 may employ one or more ranking functions, such as, for example, a ranking function 132 which may be included within and/or otherwise operatively coupled to search engine 124. Here, for example, ranking function 132 may be based, at least in part, on conditional and/or non-conditional probabilities derived from co-occurrence statistics of content and topic entities associated with the vocabulary of at least one external corpus. An example implementation of a process employing such ranking function will be described in greater detail below with reference to FIG. 2. As illustrated, IIS 102 may further include a processor 134 that may be operatively enabled to execute computer-readable instructions and/or implement various modules, for example.

In operative use, a user may access a search engine website and may submit a query by utilizing user resources 106. Browser 108 may initiate communication of one or more electrical digital signals representing such query from user resources 106 to IIS 102 via communication network 104. IIS 102 may look up search index 126 and establish a listing of web documents based on relevance according to ranking function 132. IIS 102 may then communicate such listing to user resources 106 for displaying the ranked results on user interface 110.

FIG. 2 is a flow diagram illustrating an exemplary process 200 for ranking entities associated with the vocabulary of at least one external corpus by using entity relations according to one implementation. The exemplary process may begin with a user submitting a search query to a search engine utilizing user resources. A browser associated with the user resources may initiate communication of the query as one or more electrical digital signals over a communications network. At operation 202, to quickly identify related web documents, one or more electrical digital signals representing the query may be mapped to one or more content entities associated with the vocabulary of at least one external corpus. As previously discussed, “content entities,” as used herein, may refer to one or more lexical objects descriptive of and/or associated with one or more web documents that may be matched or otherwise semantically correspond to query terms based on one or more existing query matching techniques. As a way of illustration and following the examples above, a search query term “London” may be matched with and mapped to a content entity “London” associated with the vocabulary of at least one external corpus.

An information extraction engine may employ one or more existing information extracting procedures and, for a content entity, may search the vocabulary of at least one external corpus and may extract some or all relations of interest. Such relations of interest may include, for example, a plurality of entities having one or more recognized associational attributes with such content entity and may be characterized as “topic entities,” as previously discussed. As used herein, “topic entities” may refer to one or more lexical objects that are representative of one or more concepts or aspects of a query, and may be related to the content entity through one or more types of relation (e.g., dependent, curative, subsumed, hierarchical, associational, etc.). As a way of illustration and following the examples above, in the vocabulary of at least one external corpus, London landmarks, such as Big Ben, London Eye, Tower Bridge, British Museum, Trafalgar Square, and so forth, may be characterized as “topic entities” related to the content entity “London” through a subsumed or hierarchical “city-landmarks” relation. Of course, this is merely an example and is not intended to limit claimed subject matter. In certain situations, it may be beneficial to represent implicit or transitive relations extracted from the corpus as explicit or symmetric relations. Thus, using the example above, for a given city (e.g., a content entity), it may be beneficial to search and extract some or all the landmarks (e.g., topic entities) that are located within the city (e.g., horizontal set of relationships having one or more direct hierarchical relatives), for example.

At operation 204, a process may execute instructions on a special purpose computing apparatus to map a plurality of related topic entities to a particular content entity. Once these content entity-topic entity pairs have been determined, one or more known processes or procedures may be utilized to match each pair to a corresponding relation instance (i.e., “content entity-topic entity” pairs or strings) within the vocabulary of at least one external corpus. As a way of illustration, exact string matching algorithms or procedures may be used among a plurality of string matching solutions to find occurrences of a pattern within another, typically, although not necessarily, much longer or larger pattern. Examples of such algorithms may include Karp-Rabin algorithm, Boyer-Moore algorithm, Knuth-Morris-Pratt algorithm, Real Time Matching algorithm, etc., just to name a few; although, of course, claimed subject matter is not limited to these particular examples. These and other like algorithms or procedures may be implemented, in whole or in part, to provide and/or otherwise support the mapping at operation 204. It should be noted that a normalization process may be implemented to enhance same-value string recognition and to account for particularities of various external corpora. For example, each entity may be reduced to a normalized form by removing whitespace and/or accent marks, converting letters to upper or lower case, expanding abbreviations, using variant names in multiple languages, substituting Roman numerals with Arabic, and so forth. Optionally or alternatively, such normalization process may be implemented separately from operation 204.

With regard to operation 206, having represented an entity relation (e.g., a content entity and a plurality of related topic entities) as a set of pairs or strings in the vocabulary of at least one external corpus, a search engine may employ one or more ranking functions to rank a topic entity mapped to a particular content entity using entity relations. A ranking function may be based, for example, at least in part, on one or more measures of co-occurrence of content entity-topic entity pairs. As a way of illustration, such measure of co-occurrence may comprise a probability of co-occurrence of related entities in the vocabulary of at least one external corpus. As used herein, a “probability of co-occurrence” may refer to a quantitative evaluation of the likelihood that a particular topic entity will co-occur together with a particular content entity in the vocabulary of at least one external corpus. In this example, two entities co-occur when both entities are associated with the same web document, and/or possess recognized associational attributes or some characteristic of mutual dependency. In one particular implementation, a probability of co-occurrence may be estimated as a ratio of the number of actual co-occurrences of the entities to the number of possible co-occurrences of the same entities on a predefined scale (e.g., 50%, 80%, etc., on a scale of 100). Under some circumstances, a probability of co-occurrence may be estimated, at least in part, from a numerical score (e.g., on a predefined scale) that may be assigned to or otherwise determined with respect to a particular topic entity in relation to one or more other topic entities.

According to a particular implementation, a probability of co-occurrence may be estimated, at least in part, by using subsets of conditional and/or non-conditional probabilities that, in turn, may be derived, at least in part, from one or more co-occurrence distribution tables, such as, for example, a co-occurrence matrix. In an implementation, a co-occurrence matrix may represent, at least in part, raw counts of co-occurrences and occurrences of content and topic entities within the vocabulary of at least one external corpus (e.g., the number of times content and topic entities co-occur in the corpus). It should be appreciated that a co-occurrence matrix may or may not be symmetric. In symmetric co-occurrence matrices, if a content entity co-occurs with a topic entity, a topic entity co-occurs with a content entity equally often), or:

P(content entity, topic entity)=P(topic entity, content entity) (1)

where P(content entity, topic entity) and P(topic entity, content entity) represent respective joint probabilities of the entities (e.g., of seeing a topic entity given that a content entity is located and vice versa).
Optionally or alternatively, a co-occurrence matrix may not be symmetric (e.g., the relations across the conditional (e.g., vertical) bar are not symmetric), or:

P(content entity|topic entity)≠P(topic entity|content entity) (2)

It should be noted, however, that these are merely illustrative examples relating to co-occurrence matrices that may be utilized at operation 204 and that claimed subject matter is not limited in this regard.
One or more subsets of non-conditional probabilities may be represented, at least in part, by the number of users for which a content entity-topic entity pair occurs in the vocabulary of at least one external corpus and/or by the number of web documents that associate the entities together divided by the total number of web documents in the corpus, for example. For one or more subsets of conditional statistics, a conditional probability of a content entity given a topic entity, for example, may be determined, at least in part, by counting the single and the combinational co-occurrences of the entities (e.g., from a co-occurrence matrix) and then dividing the number of web documents containing both (i.e., content and topic) entities by the number of documents containing only topic entities. As a way of illustration, a conditional probability of locating a content entity given that a topic entity is located may be estimated as follows:

$$P ( content entity \vert topic entity ) \approx \frac{P ( content entity , topic entity )}{P ( topic entity )} \qquad ( 3 )$$

Similarly, a conditional probability of locating a topic entity given that a content entity is located may be estimated as:

$$P ( topic entity \vert content entity ) \approx \frac{P ( topic entity , content entity )}{P ( content entity )} \qquad ( 4 )$$

The ranking function, then, may utilize the subset(s) of conditional and/or non-conditional probabilities to calculate the probability of co-occurrence of content entity-topic entity pairs in the vocabulary of at least one external corpus. By way of example but not limitation, one or more statistical functions may be employed to account for distribution of various conditional and/or non-conditional probabilities, such as, a median, a mean, a percentile of mean, a maximum, a number of instances, a ratio, a rate, a frequency, and/or the like or any combination thereof. As one example among many possible, a probability of co-occurrence may be represented as P_{S} and may be determined as follows:

$${P}_{S} \approx \frac{\begin{matrix}P ( content ent \vert topic ent ) + P ( topic ent \vert content ent ) + \\ P ( content ent ) + P ( topic ent )\end{matrix}}{4} \qquad ( 5 )$$

For a particular content entity, then, related topic entities may be ranked using the probability of co-occurrence of the pairs. Returning to the above examples, if a probability of co-occurrence of a content entity-topic entity pair “London-Big Ben” (or “london,bigben” as a pair of tags in the normalized form) in the vocabulary of a photo annotation corpus Flickr® is higher that a probability of co-occurrence of a content entity-topic entity pair “London-Buckingham Palace” (or “london,buckinghampalace” as a pair of tags in the normalized form), then the topic entity “Big Ben” may be ranked higher than the topic entity “Buckingham Palace” in the listing of the returned search results for the query “London.” However, it should be noted that these are merely illustrative examples relating to queries and to various external corpora and that claimed subject matter is not limited in this regard.

Next, at operation 208, multiple rank lists that are based on corpus-independent co-occurrence statistics may be merged or otherwise sorted in some manner, in the ranking function or other function associated with a search engine, to possibly enhance the relevance of the search results presented to a user. Such an example method may minimize the differences between the multiple rank lists in a case where the lists are to be combined and delivered to a user as a single listing. Any suitable rank merging algorithm or like procedure may be utilized to further the merging and/or sorting function(s) at operation 208. It should be noted that operation 208 may be optional in certain implementations.

Finally, at operation 210, the process may further execute instructions on the special purpose computing apparatus to present the search results to a user. The results may be transmitted via a communication network as one or more binary digital signals to user resources and may be displayed in the user interface. In some implementations, it may be desirable at operation 210 to utilize one or more page segmentation processes to separate all or part of a web page displaying the search results for additional functionality, as previously discussed. For example, first binary digital signals representative of a listing of ranked topic entities may be transmitted and presented to a user as a first segmented portion of a web page. Similarly, second binary digital signals representative of one or more sets of web documents associated with a particular topic entity may be transmitted and presented to a user as a second segmented portion of the web page. It should be appreciated that the first binary digital signals and the second binary digital signals may be associated with one or more displayable web pages. In addition, one or more of such digital signals may be converted to one or more analog signals and/or stored at one or more memory locations.

In some implementations, in may be desirable at block 210 to have the segmented portions of one or more web pages to be partially or substantially semantically coherent. Optionally or alternatively, a web page may be presented to a user without such semantic coherency and/or one or more segmented portions may be selectively combined. As mentioned above, such techniques may allow for improved and efficient browsing of information within a displayed web page. Of course, this is just an example relating to web page segmentation techniques to which claimed subject matter is not limited.

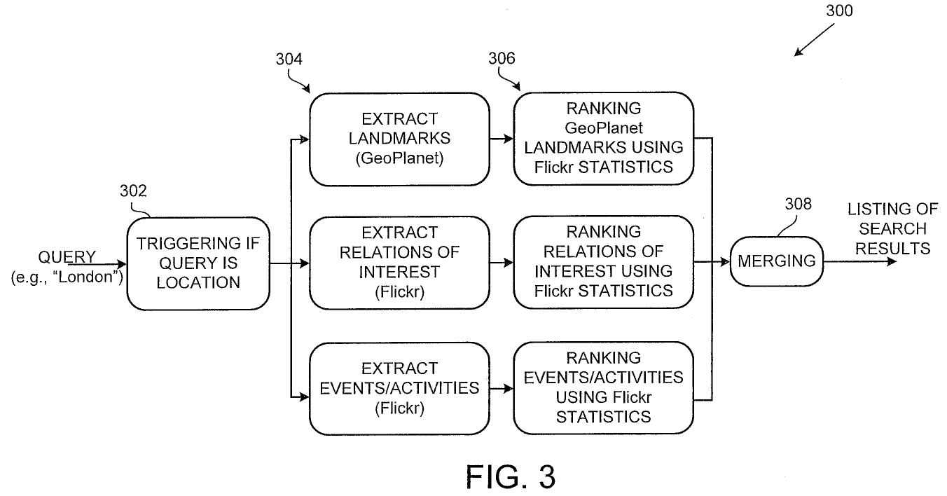

FIG. 3 is a flow diagram further illustrating the process of FIG. 2 in a non-limiting exemplary implementation where a query submitted by a user is representative of a particular geographic location. As seen in this example, at operation 302, a submitted query, such as “London,” may be matched to a corresponding content entity “London,” and a process for ranking entities (e.g., by utilizing entity relations) for a location-specific query may be triggered or initiated. At operation 304, an information extraction engine may search, for example, the vocabularies of a geographic database GeoPlanet™, and/or a photo annotation corpus Flickr®, and may extract landmarks, and/or events/activities, and/or other relations of interest (e.g., topic entities) associated with and/or related to the content entity “London.” It should be appreciated that even though two extraction corpora are illustrated at operation 304 (e.g., GeoPlanet™ and Flickr®), one external corpus (e.g., GeoPlanet™) may be used as an extraction corpus and another external corpus (e.g., Flickr®) may be used as a ranking corpus.

At operation 306, extracted landmarks, and/or events/activities, and/or other relations of interest may be ranked using corpus-specific co-occurrence statistics, as previously described. As one example among many possible, London-related landmarks (e.g., topic entities) extracted from the vocabulary of GeoPlanet™ may be ranked using co-occurrence statistics derived from the vocabulary of Flickr®. Thus, if a particular landmark (e.g., Big Ben) is estimated to have a higher probability of co-occurring together with the content entity “London” (e.g., as a tag pair “london, bigben”) within the photo annotation corpus, then such landmark may be placed higher in the listing of landmarks for London, as previously described. London-related events/activities and/or other relations of interest extracted from the vocabulary of Flickr® or other external corpora may be ranked in a similar fashion using co-occurrence statistics of related tag pairs derived over the entire photo annotation corpus, such as Flickr®, for example.

Next, at operation 308, multiple independently-ranked lists of London-related landmarks, and/or events/activities, and/or other relations of interest may be merged into a single listing to possibly enhance the relevance of the search results. In an implementation, such merged listing may reflect, for example, the top ten or top twenty of the most relevant relations for a query “London” and may comprise various combinations of landmarks, and/or events/activities, and/or other relations of interest. Any suitable merging process or procedure may be utilized to merge multiple rank lists into a single listing of the search results. It should be appreciated, that a listing of the search results may be ranked and presented to a user without such merging.

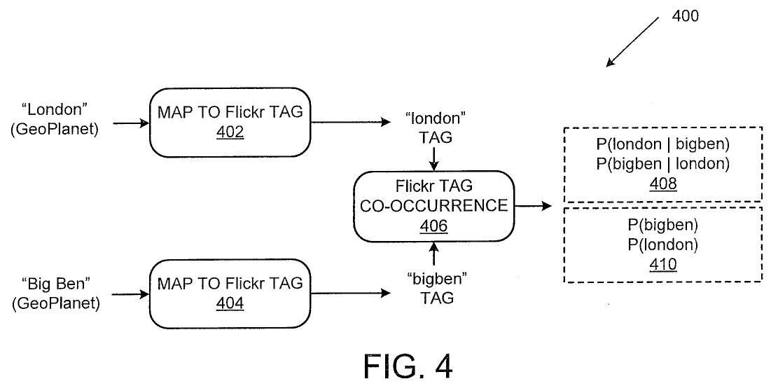

FIG. 4 is a flow diagram that illustrates certain functional features of an exemplary process 400 that may be operatively enabled to support a ranking of London-related landmarks using their relation within the vocabularies of a geographic database GeoPlanet™, and/or a photo annotation corpus Flickr®. As seen in the present example, at operation 402, the content entity “London,” extracted from or otherwise associated with the vocabulary of the database GeoPlanet™ (e.g., extraction corpus), may be mapped to a corresponding instance (e.g., a tag “london”) in the vocabulary of a photo annotation corpus Flickr®(e.g., ranking corpus). In a similar fashion, at operation 404, the topic entity “Big Ben” may be mapped to the corresponding tag “bigben” in the Flickr® database. Further, at operation 406, co-occurrence statistics of such tags over the entire Flickr® corpus may be analyzed, and one or more co-occurrence distribution tables or co-occurrence matrices may be created. From such a co-occurrence matrix, one or more subsets of conditional probabilities, indicated generally at 408, and/or one or more subsets of non-conditional probabilities, indicated generally at 410, may be derived, as previously discussed.

Subset of conditional probabilities 408 may include, for example, a conditional probability of locating the tag “london” in the photo annotation corpus Flickr® given the tag “bigben” (e.g., P(london|bigben)) and/or a conditional probability of locating “bigben” if “london” is given (e.g., P(bigben|london)). Subset of non-conditional probabilities 410 may include prior or marginal probabilities of seeing or locating the tag “bigben” and/or the tag “london” in the photo annotation corpus Flickr® (e.g., P(bigben) and/or P(london), respectively), for example. As discussed above, such subsets of conditional and/or non-conditional probabilities may be further utilized to estimate a probability of co-occurrence of the “london, bigben” pair or string in the Flickr® corpus. The pair “london, bigben” then may be ranked in relation to other Flickr® tag pairs representative of London-related landmarks within the photo annotation corpus. Of course, such details of locations, tags, content and topic entities, and/or associated external corpora are merely examples, and claimed subject matter is not so limited.

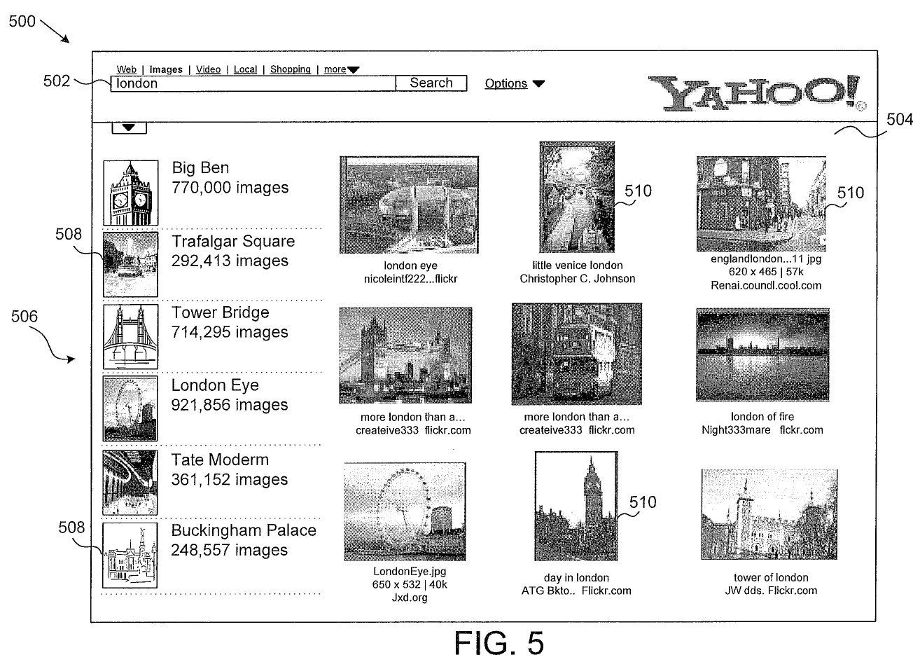

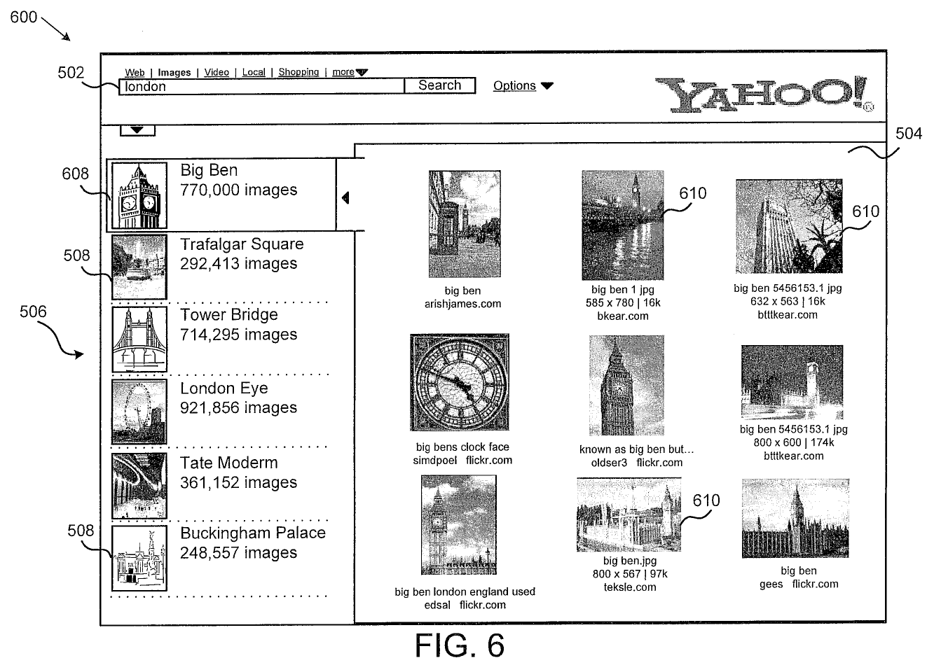

FIGS. 5-6 are illustrative representations of respective screenshot views 500 and 600 on a user display device of how a web page may display the search results in response to a query representative of a particular location, such as, for example, “London,” indicated generally at 502. As illustrated, a web page 504 may include a listing of ranked topic entities 506 displayed within one portion of the page (e.g., on the left portion of web page 504) in which each topic entity may correspond to a particular selectable tab 508. Web page 504 may further include visual content that may be displayed within another portion of the page (e.g., on the right) and may comprise, at least in part, various graphical and/or text elements including one or more images generated from a bit-mapped representation of data, such as, for example, one or more Joint Photographic Expert Group (JPEG) files. Such visual content may comprise one or more sets of one or more web documents, such as, for example, web documents 510 of FIG. 5. As illustrated, upon initial presentation of the search results to a user (e.g., before user's selection of a particular topic entity from listing 506), a portion of web page 504 may display one or more web documents 510 that may be representative of the query “London,” for example. As particularly seen in FIG. 6, after a user selects a particular topic entity, such as, for example, “Big Ben,” by clicking on a corresponding selectable tab 608, a search engine service may retrieve and web page 504 may display one or more web documents 610 electronically associated with or otherwise grouped together with respect to the topic entity “Big Ben.” Such a retrieval of related web documents may be facilitated by creation of a new or compound query based, at least in part, on the names or labels of a content entity and a selected (e.g., via a click) topic entity. In this example, when a user selects a particular topic entity from listing 506, such as, for example, “Big Ben” (e.g., by clicking on tab 608), a new query “London Big Ben” may be created and submitted to one or more search engine services to retrieve related web documents. It should be noted that such a search service may or may not be a third party service, may utilize one or more external corpora associated with process 200, and/or may use other external corpora for retrieval of web documents.

Further, by clicking on one or more web documents 610, a user may browse through a number of related web documents without leaving the original search results (e.g., listing 506). Upon reviewing web documents associated with “Big Ben,” a user may select another topic entity from listing 506 (e.g., “London Eye,” “Tower Bridge,” “Buckingham Palace,” etc.) and may receive and browse related web documents in a similar manner. As mentioned above, such techniques may allow for improved and efficient browsing of information within one or more displayable web pages. It should be appreciated that this, of course, is merely one possible example. Many forms of presenting ranked search results and/or retrieving web documents, as well as web page navigation may be employed, and claimed subject matter is not limited in this respect.

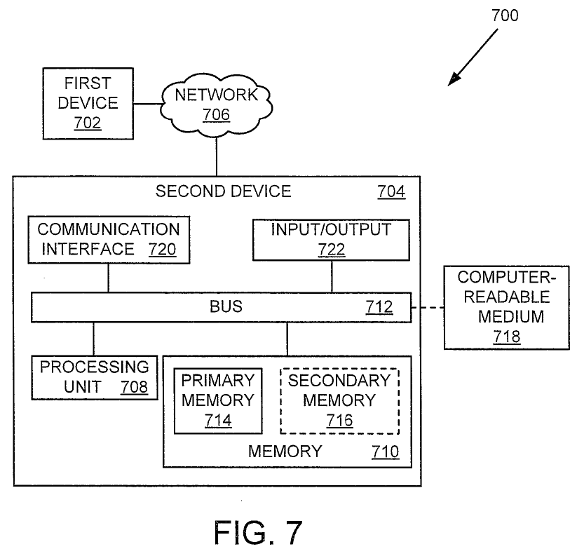

FIG. 7 is a schematic diagram illustrating an exemplary computing environment 700 that may include one or more devices that may be configurable to partially or substantially implement a process of ranking entities using one or more techniques described herein, such as, for example, ranking entities associated with the vocabulary of at least one external corpus using entity relations within the corpus.

Computing environment system 700 may include, for example, a first device 702 and a second device 704, which may be operatively coupled together via a network 706. Although not shown, optionally or alternatively, there may be additional like devices operatively coupled to network 706

In an embodiment, first device 702 and second device 704 each may be representative of any electronic device, appliance, or machine that may be configurable to exchange data over network 706. For example, first device 702 and second device 704 each may include: one or more computing devices or platforms, such as, e.g., a desktop computer, a laptop computer, a workstation, a server device, data storage units, or the like.

Network 706 may represent one or more communication links, processes, and/or resources configurable to support the exchange of data between first device 702 and second device 704. By way of example but not limitation, network 706 may include wireless and/or wired communication links, telephone or telecommunications systems, data buses or channels, optical fibers, terrestrial or satellite resources, local area networks, wide area networks, intranets, the Internet, routers or switches, and the like, or any combination thereof.

It should be appreciated that all or part of the various devices and networks shown in computing environment system 700, and the processes and methods as described herein, may be implemented using or otherwise include hardware, firmware, or any combination thereof along with software.

Thus, by way of example but not limitation, second device 704 may include at least one processing unit 708 that may be operatively coupled to a memory 710 through a bus 712. Processing unit 708 may represent one or more circuits configurable to perform at least a portion of a data computing procedure or process. As a way of illustration, processing unit 708 may include one or more processors, controllers, microprocessors, microcontrollers, application specific integrated circuits, digital signal processors, programmable logic devices, field programmable gate arrays, and the like, or any combination thereof.

Memory 710 may represent any data storage mechanism. For example, memory 710 may include a primary memory 714 and/or a secondary memory 716. Primary memory 714 may include, for example, a random access memory, read only memory, etc. While illustrated in this example as being separate from processing unit 708, it should be appreciated that all or part of primary memory 714 may be provided within or otherwise co-located/coupled with processing unit 708.

Secondary memory 716 may include, for example, the same or similar type of memory as primary memory and/or one or more data storage devices or systems, such as, for example, a disk drive, an optical disc drive, a tape drive, a solid state memory drive, etc. In certain implementations, secondary memory 716 may be operatively receptive of, or otherwise configurable to couple to, a computer-readable medium 718. Computer-readable medium 718 may include, for example, any medium that can carry and/or make accessible data, code and/or instructions for one or more of the devices in system 700.

Second device 704 may include, for example, a communication interface 720 that may provide for or otherwise support the operative coupling of second device 704 to at least network 706. By way of example but not limitation, communication interface 720 may include a network interface device or card, a modem, a router, a switch, a transceiver, and the like.

Second device 704 may include, for example, an input/output 722. Input/output 722 may represent one or more devices or features that may be configurable to accept or otherwise introduce human and/or machine inputs, and/or one or more devices or features that may be configurable to deliver or otherwise provide for human and/or machine outputs. By way of example but not limitation, input/output device 722 may include a display, speaker, keyboard, mouse, trackball, touch screen, data port, and the like.

Thus, as illustrated in the various example implementations and techniques presented herein, in accordance with certain aspects a method may be provided for use as part of a special purpose computing device and/or other like machine that accesses digital signals from memory and processes such digital signals to establish transformed digital signals which may then be stored in memory as part of one or more data files and/or a database specifying and/or otherwise associated with an index.

Some portions of the detailed description have been presented in terms of processes and/or symbolic representations of operations on data bits or binary digital signals stored within memory, such as memory within a computing system and/or other like computing device. These process descriptions and/or representations are the techniques used by those of ordinary skill in the data processing arts to convey the substance of their work to others skilled in the art. A process is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “associating”, “identifying”, “determining”, “allocating”, “establishing”, “accessing”, and/or the like refer to the actions and/or processes of a computing platform, such as a computer or a similar electronic computing device (including a special purpose computing device), that manipulates and/or transforms data represented as physical electronic and/or magnetic quantities within the computing platform's memories, registers, and/or other information (data) storage device(s), transmission device(s), and/or display device(s).

According to an implementation, one or more portions of an apparatus, such as second device 704, for example, may store one or more binary digital electronic signals representative of information expressed as a particular state of the device, here, second device 704. For example, an electronic binary digital signal representative of information may be “stored” in a portion of memory 710 by affecting or changing the state of particular memory locations, for example, to represent information as binary digital electronic signals in the form of ones or zeros. As such, in a particular implementation of an apparatus, such a change of state of a portion of a memory within a device, such the state of particular memory locations, for example, to store a binary digital electronic signal representative of information constitutes a transformation of a physical thing, here, for example, memory device 710, to a different state or thing.

While certain exemplary techniques have been described and shown herein using various methods and systems, it should be understood by those skilled in the art that various other modifications may be made, and equivalents may be substituted, without departing from claimed subject matter.

Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising:
executing instructions by a special purpose computing apparatus to:
map one or more electrical digital signals representing a query to one or more content entities;
for at least one of said one or more content entities, map a plurality of topic entities to said content entity; and
for at least one of said one or more content entities, rank topic entities mapped to said at least one of said one or more content entities based, at least in part, on a measure of co-occurrence of content entity-topic entity pairs.

2. The method of claim 1, further comprising executing instructions by a special purpose computing apparatus to transmit first binary digital signals representative of a listing of ranked topic entities to a user device via a communication interface.

3. The method of claim 1, further comprising executing instructions by a special purpose computing apparatus to transmit second binary digital signals representative of one or more sets of one or more web documents via said communication interface to said user device, wherein a particular set of said one or more web documents is associated with a particular topic entity.

4. The method of claim 3, wherein said second binary digital signals representative of said one or more sets of said one or more web documents comprise at least one joint photographic expert group (JPEG) file.

5. The method of claim 1, further comprising executing instructions by a special purpose computing apparatus to:
display on said user device said listing of said ranked topic entities based on said first binary digital signals; and
display on said user device said one or more sets of said one or more web documents based on said second binary digital signals;
wherein said signals representative of said listing of said ranked topic entities are maintained apart from said signals representative of said one or more sets of said one or more web documents.

6. The method of claim 1, wherein said content entity-topic entity pairs are associated with the vocabulary of at least one external corpus.

7. The method of claim 1, wherein said measure of co-occurrence of content entity-topic entity pairs comprises a probability of co-occurrence determined, at least in part, as a statistical probability of said content entity co-occurring together with said topic entity within the vocabulary of at least one external corpus.

8. The method of claim 1, further comprising executing instructions by a special purpose computing apparatus to merge first binary digital signals representing multiple listings of said ranked topic entities; and
transmit said merged first binary digital signals to a user device via a communication interface.

9. An article comprising:
a storage medium comprising machine-readable instructions stored thereon which, in response to being executed by a processor, at least in part direct said processor to:
map a query to one or more content entities;
for at least one of said one or more content entities, map a plurality of topic entities to said content entity; and
for at least one of said one or more content entities, rank topic entities mapped to said at least one of said one or more content entities based, at least in part, on a measure of co-occurrence of content entity-topic entity pairs.

10. The article of claim 9, wherein said instructions, if executed by said special purpose computing apparatus, further enable said special purpose computing apparatus to search the vocabulary of at least one external corpus to obtain one or more of said content entity-topic entity pairs associated with said vocabulary of at least one external corpus.

11. The article of claim 9, wherein said instructions, if executed by said special purpose computing apparatus, further enable said special purpose computing apparatus to determine a probability of co-occurrence representative of said measure of co-occurrence of content entity-topic entity pairs, wherein said probability of co-occurrence is calculated as a function of a statistical probability of said content entity co-occurring together with said topic entity within the vocabulary of at least one external corpus.

12. The article of claim 9, wherein said instructions, if executed by said special purpose computing apparatus, further enable said special purpose computing apparatus to merge first binary digital signals representing multiple listings of said ranked topic entities; and
transmit said merged first binary digital signals to a user device via a communication interface.

13. The article of claim 9, wherein said instructions, if executed by said special purpose computing apparatus, further enable said special purpose computing apparatus to:
transmit first binary digital signals representative of a listing of ranked topic entities to a user device via a communication interface; and
display on said user device said listing of said ranked topic entities based on said first binary digital signals.

14. The article of claim 13, wherein said instructions, if executed by said special purpose computing apparatus, further enable said special purpose computing apparatus to:
transmit second binary digital signals representative of one or more sets of one or more web documents via said communication interface to said user device; and
display on said user device said one or more sets of said one or more web documents based on said second binary digital signals;
wherein a particular set of said one or more web documents is associated with a particular topic entity.

15. An apparatus comprising:
a computing platform comprising:
a communication interface to receive from an electronic communication network one or more electrical digital signals transmitting information; and
one or more processors programmed with instructions to:
map one or more electrical digital signals received from said electronic communication network through said communication interface and representing a query to one or more content entities;
for at least one of said one or more content entities, map a plurality of topic entities to said content entity; and
for at least one of said one or more content entities, rank topic entities mapped to said at least one of said one or more content entities based, at least in part, on a measure of co-occurrence of content entity-topic entity pairs.

16. The apparatus of claim 15, wherein said one or more processors are further programmed to associate said content entity-topic entity pairs with the vocabulary of at least one external corpus.

17. The apparatus of claim 15, wherein said one or more processors are further programmed to transmit first binary digital signals representative of a listing of ranked topic entities to a user device via said communication interface.

18. The apparatus of claim 15, wherein said one or more processors are further programmed to transmit second binary digital signals representative of one or more sets of one or more web documents via said communication interface to said user device, wherein a particular set of said one or more web documents is associated with a particular topic entity.

19. The apparatus of claim 15, wherein said one or more processors are further programmed to:
display on said user device said listing of said ranked topic entities based on said first binary digital signals; and
display on said user device said one or more sets of said one or more web documents based on said second binary digital signals;
wherein said first binary digital signals representative of said listing of said ranked topic entities are maintained apart from said second binary digital signals representative of said one or more sets of said one or more web documents.

20. The apparatus of claim 15, wherein said measure of co-occurrence of content entity-topic entity pairs comprises a probability of co-occurrence based on a co-occurrence matrix, wherein said probability of co-occurrence is determined, at least in part, as a function of a statistical probability of said content entity co-occurring together with said topic entity within the vocabulary of at least one external corpus.
